(19) United States
(12) Patent Application Publication
(10) Pub. No.: US 2025/0245110 A1
(43) Pub. Date: Jul. 31, 2025

(54) COMPLIANCE TESTING SYSTEM AND COMPLIANCE TESTING METHOD

(71) Applicant: Rohde & Schwarz GmbH & Co. KG, Muenchen (DE)

(72) Inventor: Benoit DERAT, Muenchen (DE)

(21) Appl. No.: 18/426,678

(22) Filed: Jan. 30, 2024

(51) Int. Cl. G06F 11/263; G06F 11/22

(52) U.S. Cl. CPC G06F 11/263; G06F 11/2221

(57) ABSTRACT

A compliance testing system includes a user interface, a machine-learning circuit, and a database. The database includes compliance testing data including information on regulations and standards for performing compliance tests on different devices under test (DUT). The user interface is configured to receive a user input including text and/or speech relating to the DUT to be tested. The machine-learning circuit is configured to determine which regulations and standards are applicable to the DUT to be tested based on the user input. The machine-learning circuit is configured to generate a set of rules describing the application of the applicable regulations and standards to the DUT that is to be tested. The machine-learning circuit is configured to generate test data based on the generated set of rules. The test data may include information on compliance tests to be performed on the DUT in view of the applicable regulations and standards.

### FIELD OF THE DISCLOSURE

Embodiments of the present disclosure generally relate to a compliance testing system for testing an electronic device under test. Embodiments of the present disclosure further relate to a compliance testing method of testing an electronic device under test.

### BACKGROUND

Certain types of electronic devices, for example mobile communication devices such as smartphones, have to be tested in order to ensure that the device under test complies with the relevant regulations and standards in the respective country.

With the ever increasing diversity of the electronic devices, communication standards and regulations, it becomes increasingly more difficult to select the appropriate compliance tests for a specific device under test.

Accordingly, highly skilled personnel is required for selecting the appropriate compliance tests, for example for an admission procedure before the responsible state authority.

Thus, there is a need for a compliance testing system and a compliance testing method that facilitate the selection of compliance tests for electronic devices under test.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a compliance testing system for testing an electronic device under test. In an embodiment, the compliance testing system comprises a user interface, a machine-learning circuit, and a database. The database comprises compliance testing data, wherein the compliance testing data comprises information on regulations and standards for performing compliance tests on different devices under test. The user interface is configured to receive a user input, wherein the user input comprises text and/or speech relating to the device under test to be tested. The machine-learning circuit is configured to determine which regulations and standards are applicable to the device under test to be tested based on the user input. The machine-learning circuit is configured to generate a set of rules describing the application of the applicable regulations and standards to the device under test that is to be tested. The machine-learning circuit is configured to generate test data based on the generated set of rules, wherein the test data comprises information on compliance tests to be performed on the device under test in view of the applicable regulations and standards.

The compliance testing system according to the present disclosure is based on the idea to facilitate selecting the appropriate compliance tests by providing a machine-learning circuit that is pre-trained to select the appropriate compliance tests based on the user input.

In an embodiment, the user may formulate the user input in natural language, for example “I want to test a smartphone supporting 5G in the frequency range between 3.3 GHz and 3.8 GHz”. In an embodiment, the user may enter a corresponding text via the user interface. Alternatively or additionally, the user interface may have a speech-to-text functionality, such that the user can formulate the user input as speech, which is then converted into a corresponding text by the user interface.

In an embodiment, the machine-learning circuit processes the user input by any suitable type of language-processing technique, for example by any suitable language-processing technique known in the state of the art, thereby extracting input data regarding the device under test to be tested.

In an embodiment, the machine-learning circuit may be configured to extract key words and/or key phrases from the user input, i.e. the extracted input data may comprise key words and/or key phrases. In an example of the user input described above, the key words and/or key phrases may be “smartphone”, “5G”, and “frequency range between 3.3 GHz and 3.8 GHz”.

In an embodiment, the machine-learning circuit may further be configured to process text documents describing different regulations and standards, and may extract the corresponding compliance testing data from the text documents. For example, the machine-learning circuit may be configured to extract key words and/or key phrases from the text documents describing the different regulations and standards, i.e. the compliance testing data may comprise the key words and/or key phrases relating to the different regulations and standards.

In an embodiment, the machine-learning circuit is pre-trained to match the extracted input data to the database or to the extracted compliance testing data, thereby determining which regulations and standards are applicable to the device under test to be tested.

In an embodiment, the determined set of rules corresponds to a link or to a map between the applicable regulations and standards and the compliance tests to be performed on the device under test to be tested.

Accordingly, the machine-learning circuit automatically determines which compliance tests are to be performed on the device under test to be tested based on the generated set of rules. Thus, the expertise required from the user for selecting the correct compliance tests is reduced considerably, as the user only has to describe the device under test to be tested, and the correct compliance tests are automatically selected by the machine-learning circuit.

For example, the machine-learning circuit may comprise at least one artificial neural network that is configured to perform the functionality described above and hereinafter.

According to an aspect of the present disclosure, the test data comprises, for example, information on individual test steps and/or test sequences to be performed on the device under test in view of the applicable regulations and standards. In other words, the machine-learning circuit may be configured to automatically determine specific compliance tests and the corresponding measurement steps that are necessary for the respective compliance test. Thus, the expertise required for selecting the compliance tests is further reduced.

In an embodiment of the present disclosure, the test data comprises a list of the applicable regulations and standards. Thus, the user may be automatically informed about the regulations and standards that are relevant for testing the specific device under test to be tested. For example, the user may use this information for verifying the compliance tests selected by the machine-learning circuit.

According to another aspect of the present disclosure, the test data comprises, for example, machine-readable instructions for at least one test instrument performing the compliance tests. In an embodiment, the machine-readable instructions may be configured such that at least one test instrument can automatically set its operational parameters for performing the compliance tests. Alternatively or additionally, the machine-readable instructions may be configured such that the at least one test instrument is controlled to automatically perform the compliance tests. Thus, the compliance testing system according to the present disclosure allows for highly automated compliance testing, which further reduces the expertise required from the user.

In an embodiment of the present disclosure, the compliance testing system further comprises a visualization circuit, wherein the visualization circuit is configured to generate visualization data based on the test data. Thus, the test data may be displayed to the user in an illustrative way.

In an embodiment, the visualization data may be displayed on a display, for example on a display of a test instrument, an external display, or on a display of a computing device, such as a personal computer, a laptop, a smartphone, a table, or another type of smart device.

Another aspect of the present disclosure provides that the machine-learning circuit is configured, for example, to determine whether the user input is sufficient in order to generate the set of rules and/or in order to determine which regulations and standards are applicable to the device under test to be tested. In other words, the machine-learning circuit automatically determines whether sufficient information on the device under test is comprised in the user input for determining the applicable regulations and standards and/or for determining the set of rules.

For example, the user input may comprise the query “I want to test a smartphone supporting 5G”. This information may not be sufficient, as different countries may have different regulations regarding the allowable frequency ranges associated with the 5G standard.

In an embodiment, the machine-learning circuit may be configured to generate a user query if it is determined that the user input is insufficient, wherein the user query generated queries information on data missing in the user input. In other words, the machine-learning circuit may be configured to automatically determine which additional information on the device under test is required for determining the applicable regulations and standards and/or for determining the set of rules. The machine-learning circuit may further be configured or pre-trained to automatically query the user for the missing information.

In the example given above, the user query may be “Please input the designated countries in which the smartphone is to be deployed”.

In an embodiment, the visualization circuit described above may be configured to generate visualization data associated with the user query generated, and the visualization data may be displayed on a display.

In an embodiment of the present disclosure, the user query is formulated in natural language. In other words, the compliance test system is configured to have a conversation with the user in natural language, which facilitates the user in understanding which further information is required.

For example, the compliance testing system may be configured to initiate a chat with the user, wherein the user query generated is presented to the user in the chat. The user may reply directly in the chat, for example by entering the requested additional information.

In an embodiment, the machine-learning circuit may generate further user queries until the user has entered all information necessary for determining the applicable regulations and standards and/or for determining the set of rules.

An aspect of the present disclosure provides that the machine-learning circuit is configured, for example, to determine whether the compliance testing data is sufficient in order to generate the set of rules. In other words, the machine-learning circuit may be configured to automatically determine whether the existing regulations and standards applicable to the device under test to be tested comprise enough information in order to determine the compliance tests to be performed.

For example, the existing regulations and standards may not cover all aspects of the performance of a newly developed device under test. In this case, the machine-learning circuit may determine that the compliance testing data is insufficient for generating the set of rules.

According to another aspect of the present disclosure, the machine-learning circuit is configured, for example, to generate a user message if it is determined that the compliance testing data is insufficient in order to generate the set of rules, wherein the user message comprises information on data missing in the compliance testing data. Thus, the user may be informed that the existing regulations and standards do not cover all information necessary for determining the compliance tests to be conducted. Further, the user may be informed on which information is missing in the existing regulations and standards.

In an embodiment of the present disclosure, the user message comprises information on an authority responsible for the relevant regulations and standards. Thus, the user is informed on which authority is to be contacted regarding the regulations and standards applicable to the device under test to be tested.

Therein and in the following, the term “authority” is understood to denote an institution that is responsible for regulations and standards governing different aspects of the performance of the device under test to be tested in the respective country. For example, the authority governing the rules and regulations relating to radio devices in the United States is the Federal Communications Commission (FCC), while in the European Union the corresponding rules and regulations are governed by the individual state authorities that are organized in the European Regulators Group (ERG).

In an embodiment, the user message may comprise a pre-formulated query to the authority. In an embodiment, the pre-formulated query may comprise a query for the data or information missing in the existing regulations and standards. Thus, the user is assisted in acquiring the necessary additional standard and regulation information from the responsible authority.

According to a further aspect of the present disclosure, the user interface is configured, for example, to receive feedback data, wherein the feedback data comprises information on errors in the set of rules and/or in the test data, and wherein the machine-learning circuit is configured to adjust its operational parameters in order to minimize the error. In other words, the machine-learning circuit may be trained or re-trained based on the feedback data, such that the accuracy of the determined regulations and standards being applicable to the device under test to be tested, the accuracy of the generated set of rules, and/or the accuracy of the generated test data is enhanced.

For example, the feedback data may be provided by the user. As another example, the feedback data may be provided by an expert or by a group of experts. For example, it is also conceivable that the determined regulations and standards being applicable to the device under test to be tested, the determined set of rules, and/or the determined test data may be accessed via a cloud computing network, for example together with the corresponding user input, wherein a plurality of experts can access this information and provide the feedback data. This way, the machine-learning circuit can be trained or re-trained without an expert being present in a testing facility comprising the compliance testing system.

Another aspect of the present disclosure provides that the compliance testing system further comprises, for example, at least one test instrument, wherein the at least one test instrument is configured to determine whether the at least one test instrument is capable of performing the compliance tests to be performed on the device under test based on the test data. In other words, the test instrument may check whether the at least one test instrument fulfills requirements of the compliance tests to be performed, such as necessary frequency analysis ranges, necessary frequency generator ranges, a necessary bandwidth, a necessary sample rate, necessary error correction capabilities, a target measurement accuracy etc. Thus, it is ensured that the selected compliance tests can actually be performed by the at least one test instrument.

In an embodiment, the machine-learning circuit may be configured to generate a user query if it is determined that the at least one test instrument is not capable of performing the tests, wherein the user query comprises information on necessary adaptations of a test setup and/or necessary changes to the compliance tests to be performed.

Thus, the user may be informed about necessary changes to the test setup comprising the at least one test instrument. For example, the user query may comprise information about necessary additional test instruments or a necessary replacement of the at least one test instrument.

Alternatively or additionally, the user may be informed about necessary changes to the compliance tests to be conducted, for example a reduction of a frequency range to be tested, a lowered target measurement accuracy, etc.

According to an aspect of the present disclosure, the compliance testing system further comprises, for example, at least one test instrument, wherein the at least one test instrument is configured to perform the compliance tests to be performed on the device under test, thereby obtaining measurement data, and wherein the machine-learning circuit is configured to generate a test report based on the measurement data. Thus, the user is assisted in generating the test report for the compliance tests performed.

In an embodiment, the machine-learning circuit may be configured to generate the test report in a format required by the authority responsible for the applicable regulations and standards. Thus, the user is for example assisted in providing the measurement data for an admission procedure of the device under test before the responsible authority.

In an embodiment of the present disclosure, the test report is formulated in natural language. Thus, the test report is presented to the user in an easily understandable fashion.

Embodiments of the present disclosure further provide a compliance testing method of testing an electronic device under test. In an embodiment, the compliance testing method comprises the steps of: receiving, by a user interface, a user input, wherein the user input comprises text and/or speech relating to the device under test to be tested, determining, by a machine-learning circuit, which regulations and standards are applicable to the device under test to be tested based on the user input and based on compliance testing data, wherein the compliance testing data comprises information on regulations and standards for performing compliance tests on different devices under test, generating, by the machine-learning circuit, a set of rules describing the application of the applicable regulations and standards to the device under test that is to be tested, and generating, by the machine-learning circuit, test data based on the generated set of rules, wherein the test data comprises information on compliance tests to be performed on the device under test in view of the applicable regulations and standards.

In an embodiment, any embodiment of the compliance testing system described above may be configured to perform the compliance testing method.

Regarding the advantages and further properties of the compliance testing method, reference is made to the explanations given above with respect to the compliance testing system, which also hold for the compliance testing method and vice versa.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a compliance testing system according to an embodiment of the present disclosure;

FIG. 2 shows an example flow chart of a compliance testing method according to an embodiment of the present disclosure;

FIG. 3 shows an example of the machine-learning circuit of the compliance testing system of FIG. 1 in more detail; and

FIG. 4 shows another example of a flow chart of a compliance testing method according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

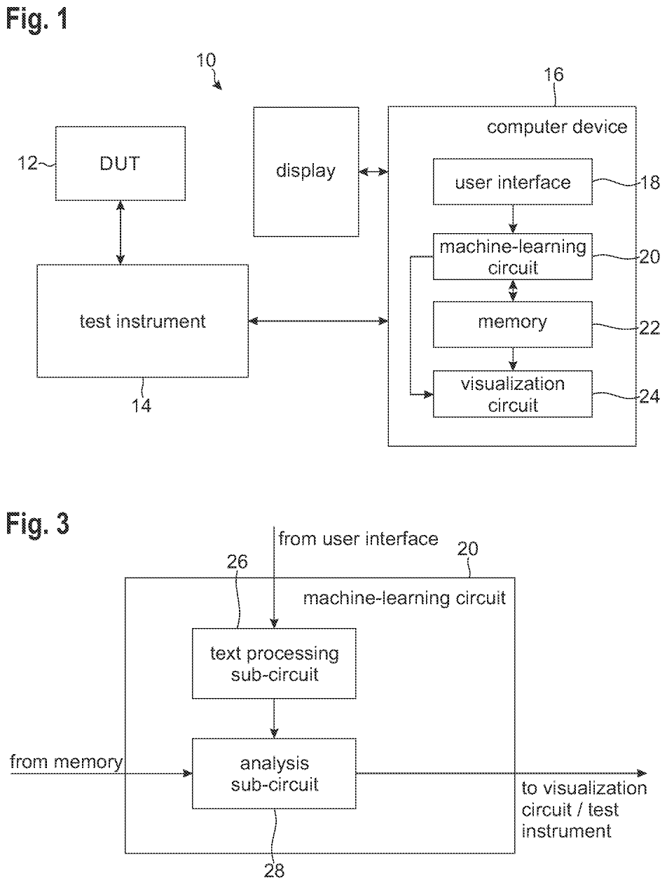

FIG. 1 schematically shows an example of a compliance testing system 10 for testing an electronic device under test 12. In general, the device under test 12 may be any type of electronic device that is configured to generate and/or process signals, for example radio frequency (RF) signals.

For example, the device under test 12 may be a mobile communication device, such as a smartphone, a tablet, an RF antenna, a base station, etc. As another example, the device under test 12 may be an electronic computing device such as a personal computer, a laptop, a chip such as a central processing unit, a graphics processing unit, a game console or any other type of computer device. In a further example, the device under test 12 may be a wireless communication device such as a WLAN router, a handheld radio, a stationary radio, etc. As further example, the device under test 12 may be a radar system, for example an automotive radar system, or a LiDAR system, for example an automotive LiDAR system.

As shown in FIG. 1, The compliance testing system 10 further comprises at least one test instrument 14 and a computer device 16. In general, the at least one test instrument 14 is configured to perform compliance tests on the device under test 12.

The type of the at least one test instrument 14 may depend on the type of the device under test 12 to be tested. For example, the at least one test instrument 14 may be or comprise an oscilloscope, a spectrum analyzer, a signal analyzer, a vector network analyzer, a mobile communication tester, a power meter, a signal generator such as an arbitrary waveform generator, an over-the-air test system, a radar test system, a LiDAR test system, etc. However, it is to be understood that the compliance testing system may comprise any other suitable type of test instrument.

Hereinafter, it is assumed without restriction of generality that the compliance testing system 10 comprises one test instrument 14.

The computer device 16 is connected to the test instrument 14 in a signal-transmitting manner, i.e. by any suitable type of wired or wireless connection. For example, the computer device 16 may be a personal computer, a laptop, a smartphone, a tablet, or any other suitable type of smart device. The computer device 16 may comprise or be connected to peripheral input devices such as a keyboard, a computer mouse, a microphone, a trackpad, etc.

As shown in the embodiment of FIG. 1, the computer device 16 comprises a user interface 18, a machine-learning circuit 20, a memory 22, and a visualization circuit 24. The memory 22 comprises a database of compliance testing data. The compliance testing data comprises information on regulations and standards for performing compliance tests on different devices under test.

It is noted that the database may, alternatively or additionally, be partially or completely integrated into a further computing device, such as a server, that is connected to the computer device 16. In an embodiment, the further computing device may be connected to the computer device 16 via the Internet, via a wide area network, a local area network, or another suitable network.

In the following, the example case of the database being integrated into the memory 22 of the computer device 16 is described without restriction of generality.

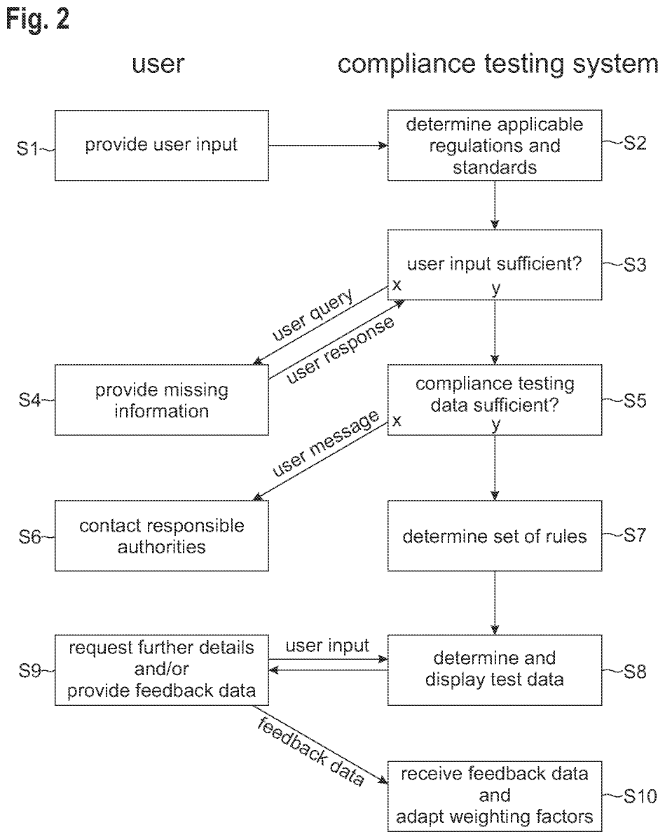

In general, the compliance testing system 10 is configured to assist a user in selecting and performing the appropriate compliance tests for testing the device under test 12. In an embodiment, the compliance testing system 10 is configured to perform a compliance testing method, an example of which is described hereinafter with respect to FIGS. 2-4.

FIG. 2 shows a flow chart of the compliance testing method, wherein the left hand side of FIG. 2 labeled “user” indicates the steps performed by the user, while the right hand side labeled “compliance testing system” indicates the steps performed by the compliance testing system 10.

The user provides a user input relating to the device under test 12 to the user interface 18, i.e. the user input is received by the user interface 18 (step S1). In an embodiment, the user input may be received in text form and/or in speech form.

If the user input is received in speech form, the user interface 18 may have a speech-to-text functionality, such that the user can formulate the user input as speech, which is then converted into a corresponding text by the user interface 18. Therein, any suitable speech recognition technique known in the state of the art may be used. Accordingly, the user input is received in text form or converted into text form.

The user interface 18 is configured to forward the user input, i.e. the user input in text form, to the machine-learning circuit 20. As is illustrated in FIG. 3, the machine-learning circuit 20 comprises a text processing sub-circuit 26 that is configured to receive the user input in text form, and an analysis sub-circuit 28 that is connected to the text-processing sub-circuit 26. The text processing sub-circuit 26 and/or the analysis sub-circuit 28 may be or comprise an artificial neural network that is configured to perform the functionalities described hereinafter.

The text processing sub-circuit 26 is configured to process the user input by any suitable type of language-processing technique, for example by any suitable language-processing technique known in the state of the art, thereby extracting input data regarding the device under test 12 to be tested. For example, the text processing sub-circuit 26 may be configured to extract key words and/or key phrases from the user input, i.e. the extracted input data may comprise key words and/or key phrases. In a certain example, the user may input “I want to test a handheld radio for civil communication”. In this case, the extracted input data may comprise the key words or the key phrases “handheld radio” and “civil communication”.

The text processing sub-circuit 26 is configured to forward the extracted input data, for example the extracted key words and/or key phrases, to the analysis sub-circuit 28. The analysis sub-circuit 28 is configured to receive the input data extracted by the text processing sub-circuit 26 as well as the compliance testing data from the memory 22.

The analysis sub-circuit 28 determines, based on the user input and the compliance testing data, which regulations and standards are applicable to the device under test 12 to be tested (step S2). In an embodiment, the analysis sub-circuit 28 is pre-trained to determine, based on the user input and based on the compliance testing data, which regulations and standards are applicable to the device under test 12 to be tested.

In an embodiment, the analysis sub-circuit 28 is pre-trained to determine which regulations and standards are applicable to the device under test 12 to be tested based on the input data extracted from the user input and based on the compliance testing data. In an embodiment, the analysis sub-circuit 28 may match the extracted key words and/or key phrases to the compliance testing data, thereby determining which regulations and standards are applicable to the device under test 12.

The information comprised in the user input may be insufficient in order to determine the regulations and standards that are applicable to the device under test 12 and/or for selecting the appropriate compliance tests for the device under test 12. Accordingly, the machine-learning circuit 20 or the analysis sub-circuit 28 may determine, based on the user input and based on the compliance testing data, whether the user input is sufficient for determining the regulations and standards that are applicable to the device under test 12 and/or for selecting the appropriate compliance tests for the device under test 12 (step S3). In an embodiment, the analysis sub-circuit 28 may be pre-trained to determine whether the user input is based on the input information extracted from the user input and based on the compliance testing data.

If the analysis sub-circuit 28 determines that the user input is insufficient, the analysis sub-circuit 28 may automatically determine which additional information on the device under test is required for determining the applicable regulations and standards and/or for determining the set of rules. In the example user input given above, “I want to test a handheld radio for civil communication”, the analysis sub-circuit 28 may determine that the user input is insufficient, as the user input neither states the country or countries in which the handheld radio shall be utilized, nor the frequency ranges that are to be used by the handheld radio.

In an embodiment, the analysis sub-circuit 28 may generate a user query that queries the information determined to be missing in the user input, and the user query may be visualized on the display 30 by the visualization circuit 24. In an embodiment, a chat comprising the user query may be opened and displayed on the display 30, wherein the user query may be formulated in natural language. In the example given above, the user query may be a text message stating, “Please specify the countries of intended use and the supported frequency ranges”.

The user can then provide the missing information via the user interface 18 (step S4), and the machine-learning circuit 20 may proceed with determining the applicable regulations and standards, a set of rules, and test data as described above and hereinafter. In an embodiment, the analysis sub-circuit 28 may keep generating user queries for the missing information until the user has provided all necessary information on the device under test 12.

In an embodiment, the machine-learning circuit 20 or the analysis sub-circuit 28 may further determine whether the compliance testing data is sufficient in order to generate the set of rules, i.e. whether the existing regulations and standards cover all relevant aspects for performing the compliance tests on the device under test 12 (step S5).

The analysis sub-circuit 28 may generate a user message if it is determined that the compliance testing data is insufficient in order to generate the set of rules, wherein the user message comprises information on data missing in the compliance testing data. The user message may be formulated in natural language, and may be displayed on the display 30. For example, the user message may comprise information on which regulations and standards are applicable to the device under test 12, and/or which information is missing in the existing regulations and standards.

Alternatively or additionally, the user message may comprise information on an authority responsible for the relevant regulations and standards. In an embodiment, the user message may comprise a pre-formulated query to the authority comprising the data or information missing in the existing regulations and standards.

Based on the user message, the user may contact the authorities responsible for the regulations and standards that are applicable to the device under test 12 (step S6).

If both the user input and the compliance testing data are sufficient, the analysis sub-circuit 28 may generate a set of rules describing how the applicable regulations and standards are to be applied to the device under test 12 (step S7).

In general, the set of rules provide a link or a map between the applicable regulations and standards and compliance tests to be performed on the device under test 12. For example, the set of rules may comprise information on the types of operational parameters that need to be tested in view of the applicable regulations and standards, the operational parameter ranges that need to be tested in view of the applicable regulations and standards, and/or specific types of compliance tests that have to be performed in view of the applicable regulations and standards.

The analysis sub-circuit 28 generates test data based on the generated set of rules (step S8). In general, the test data comprises information on compliance tests to be performed on the device under test 12 in view of the regulations and standards that are applicable to the device under test 12.

In an embodiment, the test data may comprise the individual tests steps of the compliance tests to be performed, and/or compliance test sequences to be performed on the device under test 12 in view of the regulations and standards that are applicable to the device under test 12. In an embodiment, the compliance tests to be performed may be automatically optimized by the machine-learning circuit 20 or by the analysis sub-circuit 28, such that the compliance tests to be performed are an optimal set of tests.

For example, the machine-learning circuit 20 or the analysis sub-circuit may take exclusion criteria into account for determining the order of the individual compliance tests, wherein the exclusion criteria relate to interdependencies of the individual tests. In a certain example, if the device under test 12 passes certain compliance tests relating to a 5G sub-protocol, the corresponding 4G sub-protocols do not need to be tested, as they are automatically passed by the device under test 12.

Alternatively or additionally, the test data may comprise machine-readable instructions for the at least one test instrument 14. Based on the machine-readable instructions, the test instrument 14 may be controlled to automatically perform the compliance tests selected by the analysis sub-circuit 28.

Optionally, the test data may further comprise a list of the regulations and standards that are applicable to the device under test 12.

In a certain example, the user may input the information “mobile phone, size 12”, supported frequency bands and RATs: LTE Band 89, sales region: US”. In this case, the test data may comprise the information “A device under test with above parameters has to undergo TRP measurements according to a CTIA test plan and SAR testing according to IEC-1 low—mid—high frequency channels”.

In an embodiment, the test data generated by the analysis sub-circuit 28 is forwarded to the visualization circuit 24. The visualization circuit 24 is configured to generate visualization data associated with the test data generated by the analysis sub-circuit 28. In the example embodiment shown in FIG. 1, the visualization data may be displayed on an external display 30 that is provided separately from the computer device 16 and from the test instrument 14. However, it is also conceivable that the display 30 may be integrated into the computer device 16 or into the test instrument 14.

The user may request further details on the compliance tests to be performed and/or on the applicable regulations and standards by providing a corresponding user input to the user interface 18 (step S9).

The analysis sub-circuit 28 may update the test data according to the request of the user, and the updated test data may be displayed on the display 30. Therein, the machine-learning circuit 20, for example the analysis sub-circuit 28 is already pre-trained to perform the functionalities described above. However, the machine-learning circuit 20, for example the analysis sub-circuit 28, may further be trained and/or re-trained by providing feedback data.

In an embodiment, the feedback data may be received via the user interface 18 from the user, from an expert, or from a group of experts. For example, the feedback data may comprise information on errors in the set of rules and/or in the test data.

The machine-learning circuit 20, for example the analysis sub-circuit 28, may adjust its operational parameters or its weighting factors in order to minimize the error (step S10). Accordingly, the machine-learning circuit 20 or the analysis sub-circuit 28 may be trained or re-trained by reinforcement learning.

The test data may further be forwarded to the test instrument 14, for example if the test data comprises the machine-readable instructions.

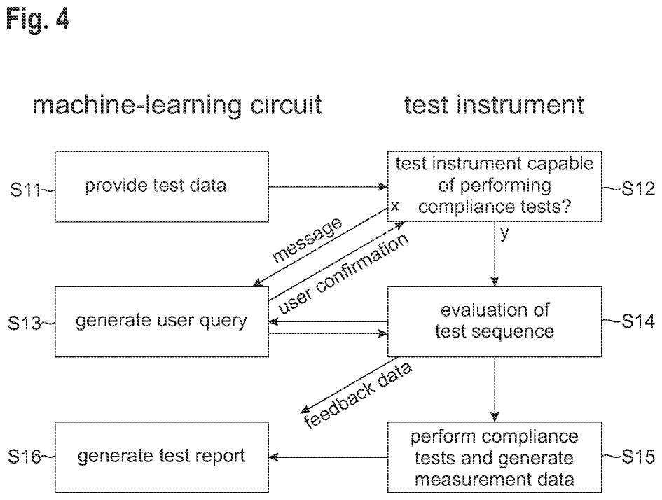

FIG. 4 shows an example flow chart of additional steps of the compliance testing method may perform, wherein the left hand side of FIG. 4 labeled “machine-learning circuit” indicates the steps performed by the machine-learning circuit 20, while the right hand side labeled “test instrument” indicates the steps performed by the test instrument 14, or by a measurement software or test sequencer associated with the test instrument 14.

Hereinafter, it is assumed without restriction of generality that the test instrument 14 performs the corresponding steps described below.

In an embodiment, the machine-learning circuit 20 provides the test data to the test instrument 14 (step S11).

The test instrument 14 determines, based on the test data, whether the test instrument 14 is capable of performing the compliance tests associated with the test data on the device under test 12 (step S12).

For example, the test instrument 14 may assess whether the test instrument 14 fulfills requirements of the compliance tests relating to operational parameters of the test instrument 14, such as necessary frequency analysis ranges, necessary frequency generator ranges, a necessary bandwidth, a necessary sample rate, necessary error correction capabilities, a target measurement accuracy, etc.

If the test instrument 14 determines that the test instrument 14 is not capable of performing the compliance tests, a corresponding message may be sent to the machine-learning circuit 20 by the test instrument 14, wherein the message comprises information on reasons why the compliance tests cannot be performed. For example, the message sent by the test instrument 14 may comprise information on insufficient operational parameter ranges or other restrictions of the test instrument 14.

A user query may be generated by the machine-learning circuit 20, for example by the analysis sub-circuit 28, and the user query may be displayed on the display 30 (step S13).

The user query may comprise information on necessary adaptations of a test setup and/or necessary changes to the compliance tests to be performed. For example, the user query may comprise information on necessary changes to the test setup comprising the test instrument 14, such as necessary additional test instruments or a necessary replacement of the test instrument 14. Alternatively or additionally, the user may be informed about necessary changes to the compliance tests to be conducted, for example a reduction of a frequency range to be tested, a lowered target measurement accuracy, etc.

In an embodiment, the user may be asked to confirm the necessary changes to the compliance tests to be conducted, and the correspondingly changed compliance tests may then be performed by the test instrument 14, for example automatically.

It is noted that the machine-learning circuit 20 or the analysis sub-circuit 28 may be pre-trained to determine, based on the test data, whether the test instrument 14 is capable of performing the compliance tests associated with the test data on the device under test 12.

In this case, the user may input the corresponding relevant data regarding the test instrument 14 via the user interface 18.

If data regarding the test instrument 14 is missing in order to assess whether test instrument 14 capable of performing the compliance tests, a corresponding user query may be generated by the analysis sub-circuit 28 that prompts the user to input the missing data regarding the test instrument 14.

If the test instrument 14 determines that the test instrument 14 is capable of performing the compliance tests, the test instrument 14 may evaluate a test sequence comprised in the test data, i.e. a test sequence of the selected compliance tests (step S14).

For example, the test instrument 14 may determine that another order of the individual tests may be more optimal, that there are redundant test steps in the test sequence, that one or more test steps should be repeated, or that there are test steps missing in the test sequence.

In an embodiment, a corresponding message may be sent to the machine-learning circuit 20 by the test instrument 14, wherein the message comprises information on suggested adaptations of the test sequence. The machine-learning circuit 20 or the analysis sub-circuit 28 may generate a corresponding user query asking the user for confirmation of the adapted test sequence, and the user query may be displayed on the display 30. The user may confirm or reject the suggested adaptations by providing a corresponding user input to the user interface 18.

If the user confirms the suggested adaptations, corresponding feedback data may be generated by the test instrument 14 that is provided to the machine-learning circuit 20. In a certain example, if the test data comprises a test sequence with several test steps, the feedback data may comprise information on errors in the test sequence with respect to the order of the individual steps, with respect to dispensable test steps in the test sequence, and/or with respect to test steps missing in the test sequence.

In an embodiment, the machine-learning circuit 20, for example the analysis sub-circuit 28, may adjust its operational parameters or its weighting factors based on the feedback data.

The compliance tests may be performed by the test instrument 14 based on the test data, thereby obtaining measurement data (step S15). In an embodiment, the compliance tests may be performed automatically based on the machine-readable instructions comprised in the test data.

The measurement data may be transmitted to the machine-learning circuit 20 or to the analysis sub-circuit 28, and the analysis sub-circuit 28 may generate a test report based on the measurement data (step S16). In an embodiment, the test report may be visualized on the display 30 by the visualization circuit 24, for example in natural language. Alternatively or additionally, the test report may be generated in a format that is required by the authority responsible for the regulations and standards applicable to the device under test 12.

The user may, for example, request further details and/or another format of the test report via the user interface 18, and the analysis sub-circuit 28 may adapt the test report according to the request of the user. In other words, the user may customize the test report by providing a corresponding user input to the user interface 18.

Certain embodiments disclosed herein include systems, apparatus, modules, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implemented the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the apparatus or components thereof, such as the device under test 12, the test instrument 14 and the computer device 16, etc., referenced above include circuitry programmed to carry out one or more steps of any of the methods disclosed herein. In some embodiments, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions include applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible to a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In some embodiments, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A compliance testing system for testing an electronic device under test, the compliance testing system comprising a user interface, a machine-learning circuit, and a database,
wherein the database comprises compliance testing data, wherein the compliance testing data comprises information on regulations and standards for performing compliance tests on different devices under test,
wherein the user interface is configured to receive a user input, wherein the user input comprises text and/or speech relating to the device under test to be tested,
wherein the machine-learning circuit is configured to determine which regulations and standards are applicable to the device under test to be tested based on the user input,
wherein the machine-learning circuit is configured to generate a set of rules describing the application of the applicable regulations and standards to the device under test that is to be tested, and
wherein the machine-learning circuit is configured to generate test data based on the generated set of rules, wherein the test data comprises information on compliance tests to be performed on the device under test in view of the applicable regulations and standards.

2. The compliance testing system of claim 1, wherein the test data comprises information on individual test steps and/or test sequences to be performed on the device under test in view of the applicable regulations and standards.

3. The compliance testing system of claim 1, wherein the test data comprises a list of the applicable regulations and standards.

4. The compliance testing system of claim 1, wherein the test data comprises machine-readable instructions for at least one test instrument performing the compliance tests.

5. The compliance testing system of claim 1, further comprising a visualization circuit, wherein the visualization circuit is configured to generate visualization data based on the test data.

6. The compliance testing system of claim 1, wherein the machine-learning circuit is configured to determine whether the user input is sufficient in order to generate the set of rules and/or in order to determine which regulations and standards are applicable to the device under test to be tested.

7. The compliance testing system of claim 6, wherein the machine-learning circuit is configured to generate a user query if it is determined that the user input is insufficient, wherein the user query generated queries information on data missing in the user input.

8. The compliance testing system of claim 7, wherein the user query is formulated in natural language.

9. The compliance testing system of claim 1, wherein the machine-learning circuit is configured to determine whether the compliance testing data is sufficient in order to generate the set of rules.

10. The compliance testing system of claim 9, wherein the machine-learning circuit is configured to generate a user message if it is determined that the compliance testing data is insufficient in order to generate the set of rules, wherein the user message comprises information on data missing in the compliance testing data.

11. The compliance testing system of claim 10, wherein the user message comprises information on an authority responsible for the relevant regulations and standards.

12. The compliance testing system of claim 11, wherein the user message comprises a pre-formulated query to the authority.

13. The compliance testing system of claim 1, wherein the user interface is configured to receive feedback data, wherein the feedback data comprises information on errors in the set of rules and/or in the test data, and wherein the machine-learning circuit is configured to adjust its operational parameters in order to minimize the error.

14. The compliance testing system of claim 1, wherein the compliance testing system further comprises at least one test instrument, wherein the at least one test instrument is configured to determine whether the at least one test instrument is capable of performing the compliance tests to be performed on the device under test based on the test data.

15. The compliance testing system of claim 14, wherein the machine-learning circuit is configured to generate a user query if it is determined that the at least one test instrument is not capable of performing the tests, wherein the user query comprises information on necessary adaptations of a test setup and/or necessary changes to the compliance tests to be performed.

16. The compliance testing system of claim 1, wherein the compliance testing system further comprises at least one test instrument, wherein the at least one test instrument is configured to perform the compliance tests to be performed on the device under test, thereby obtaining measurement data, and wherein the machine-learning circuit is configured to generate a test report based on the measurement data.

17. The compliance testing system of claim 16, wherein the test report is formulated in natural language.

18. A compliance testing method of testing an electronic device under test, the compliance testing method comprising the steps of
receiving, by a user interface, a user input, wherein the user input comprises text and/or speech relating to the device under test to be tested;
determining, by a machine-learning circuit, which regulations and standards are applicable to the device under test to be tested based on the user input and based on compliance testing data, wherein the compliance testing data comprises information on regulations and standards for performing compliance tests on different devices under test;
generating, by the machine-learning circuit, a set of rules describing the application of the applicable regulations and standards to the device under test that is to be tested; and
generating, by the machine-learning circuit, test data based on the generated set of rules, wherein the test data comprises information on compliance tests to be performed on the device under test in view of the applicable regulations and standards.
